(19) United States
(12) Patent Application Publication
(10) Pub. No.: US 2008/0023597 A1
(43) Pub. Date: Jan. 31, 2008

(54) ENHANCED COMFORT WRIST REST ASSEMBLY

(75) Inventors: Daniel M. Wyner, North Scituate, RI (US); Thomas F. Cafaro, Foster, RI (US); Richard Christopher Stokes, Cambridge, MA (US); Roger J. LaFlamme, Enfield, CT (US); Richard B. Fox, Smithfield, RI (US)

Correspondence Address: BARLOW, JOSEPHS & HOLMES, LTD., 101 DYER STREET, 5TH FLOOR, PROVIDENCE, RI, 02903, US

(73) Assignee: POLYWORKS, INC., Lincoln, RI (US)

(21) Appl. No.: 11/828,856

(22) Filed: Jul. 26, 2007

Related U.S. Application Data
(60) Provisional application No. 60/820,634, filed on Jul. 28, 2006.

(51) Int. Cl. B43L 15/00

(52) U.S. Cl. 248/118.3

(57) ABSTRACT

An adjustable wrist rest assembly includes a base housing and a pump assembly residing in the housing. A bladder is provided in fluid communication with the pump where the bladder is configured and arranged to receive a user's wrist region thereon. A optional pump button may be connected to the pump assembly with an optional release button connected to the pump assembly. The configuration of the bladder custom adjusts the receipt of the user's wrist region thereon and the comfort associated therewith.

### CROSS-REFERENCE TO RELATED APPLICATION

This application is related to and claims priority from earlier filed provisional patent application Ser. No. 60/820,634, filed Jul. 28, 2006, incorporated herein by reference.

### BACKGROUND OF THE INVENTION

This invention relates to a wrist rest with enhanced comfort features. More specifically, the invention provides for a wrist rest which is adjustable in height and firmness, and where these features can be adjusted or varied manually and/or automatically. The ability to adjust the height or profile of the wrist rest on a regular basis allows the user to vary the repetitive hand movements and thus potentially avoid Carpal Tunnel Syndrome or other hand wrist or finger pain. In some embodiments of this invention, the USB port of the computer device is used to power an air pump to allow for easy or automatic/interactive adjustability of the wrist rest. In addition, this invention provides for the potential addition of heat, cooling and/or massage features to the wrist rest which will also enhance comfort. Part of the invention is relates to the powering of these heat, cooling and massage features through the USB port of a computer device. Some embodiments of this invention also have significant advantages over the prior art in terms of reduced weight or physical space for portability due to the utilization of an air chamber.

The growing use of computers and their associated input devices has led to a tremendous increase in Repetitive Stress Injuries among computer users. Examples of Repetitive Stress Injuries include aching hands, shoulders and neck, and particularly disorders relating to the wrists and hands, with the most common disorder being Carpal Tunnel Syndrome. Carpal Tunnel Syndrome is characterized by soreness, tenderness and weakness of the muscles of the thumb resulting from pressure on the median nerve at the point at which it goes through the carpal tunnel of the wrist. Carpal Tunnel Syndrome may result from long periods of repetitive motion with the hands and fingers, such as from manipulating a computer keyboard, laptop or portable computer, computer mouse or other input device.

As the general public has become more aware of the dangers of Repetitive Stress Injuries, the demand for products that help to alleviate these conditions has grown. There have been many attempts in the prior art to address these concerns. There are now numerous products that are marketed for the purpose of supporting the hands and wrists during computer input, and for absorbing the vibrations which result from using such computer input devices. These products include vibration absorbing structures for supporting keyboards and the like, and also cushioning support pads (e.g., foam or gel pads) for supporting a user's wrists or arms that are generally known as wrist rests or wrist supports. These wrist support or wrist rest assemblies are commonly made from a variety of soft cushion materials including foams and gels, and are frequently covered with an aesthetic fabric on the surface allowing the users hands to move comfortably across the rest. These known wrist rest constructions have generally attempted to provide a supportive surface for the wrist that has a comfortable cushioned feel. Much of the prior art has claimed advantages in “better quality of support” using varieties of layers of cushioning material. Some of the prior art has tried to claim some adjustability or some other comfort enhancing features such as cooling, but none of the prior art has allowed for an easily adjustable and interactively adjustable wrist rest as is described in the current invention. In addition, none of the prior art has provided for heating and massage which can further alleviate Repetitive Stress Injuries, nor has the prior art suggested the novel methods of delivering these features.

One such wrist rest structure described in the prior art is the 3M Gel-Filled Adjustable Wrist Rest, commercially available from Minnesota Mining and Manufacturing Company, St. Paul, Minn. The 3M wrist rest has a rigid base assembly upon which is mounted an elongate wrist support pad. The pad is formed from a layer of resilient gel mounted on the base assembly and covered by a liquid impervious cover. The layer of gel in the pad helps maintain a user's wrists in a neutral position with a portion of the layer of gel conforming to the supported wrists to distribute the weight of the wrists over a wide area while affording significant motion of the wrists along the top surface of the elongate pad. The 3M Gel-Filled Wrist Rest is described by U.S. Pat. No. 5,547,154. While this product provides a soft comfortable structure, it suffers from many disadvantages. It provides for none of the adjustability and variability allowed by the current invention, as will be described in detail below, and it leaves the users wrists in a static and possibly non-ideal orientation during input. In addition, this 3M product does not provide massage and/or heat and cooling which are two other comfort enhancing advantages of the current invention. Also, the wrist rest described by the 3M prior art is quite heavy, and is not readily portable due to its weight, which makes it less than ideal for use with a laptop or portable computer system.

Another prior art gel-based wrist rest construction technique is disclosed in U.S. Pat. No. 5,356,099 to Sereboff. The Sereboff '099 patent discloses a wrist support system which has a liquid containing pack that is filled with either a liquid or a gel composition. According to the patent, the liquid containing pack is for resiliently supporting and conforming to the contours of the palm and wrist area when a user is operating a keyboard. In addition to providing the claimed “resilient support”, the liquid containing pack is releasably fastenable to a base to form a somewhat reconfigurable wrist support system. While somewhat reconfigurable because the liquid pack can be moved around, the Sereboff patent does not provide for any true height adjustability as described in the current invention, nor does it contemplate any idea of easy or interactive adjustability, nor does it provide for the ability to continually or automatically vary the profile of the wrist rest as is described in the current invention. It also does not offer the weight savings of the current invention.

While in general, many of the wrist rest assemblies as described in the prior art will provide for a comfortable platform to rest the wrist, they still leave the user's wrist in a static data entry position, and thus they still may be susceptible to strain from continuous repetitive motions. In addition, these fixed wrist rests are not adjustable by the user and thus may not put the user in their most comfortable typing position. The present invention allows for a wrist rest which is both adjustable in height and firmness, allowing customization by the user. In addition, the present invention allows this adjustment to take place automatically if desired, eliminating the continuous identical repetitive motions through varying the angle of the wrist on a continuous or intermittent basis.

There have been examples in the prior art of wrist rest constructions that attempt to have height adjustability. For example, published US patent application #20030132359 by Timothy Brophy (Jul. 17, 2003) describes a wrist rest assembly with a removable set of spacers that can be inserted into a cavity in the product to adjust the height of the wrist rest. While Brophy realizes that there is a need for adjustability, his method of achieving it has none of the convenience nor interactive features contemplated by the current invention. The Brophy invention describes a static height adjustment feature which cannot be adjusted automatically or easily by the user, and also does not contemplate the other comfort features such as heat, cooling and massage described in the current invention.

There have also been attempts in the prior art to provide some other “comfort” features in a wrist support, but none of the prior art has integrated heat or massage into the product as contemplated by the current invention. U.S. Pat. No. 5,476,491 to Mayn discloses a gel wrist support for computer users incorporating a cold gel pack to reduce pain and inflammation. The wrist support has a sealed, moisture proof envelope filled with gel and covered with a soft material. The wrist support is cooled in a freezer to serve as a therapeutic gel cold pack that is applied to the user's wrists during use (to cushion, absorb heat and reduce pain and inflammation). This product, while attempting to provide therapeutic cold to the wrist, does so in an inconvenient way, having the user returning an ice-pack in the freezer on an intermittent basis. This prior art does not contemplate the use of heat, nor does it provide for the unique convenient and interactive delivery method for cooling described in the current invention.

### SUMMARY OF THE INVENTION

The present invention preserves the advantages of prior art wrist rests. In addition, it provides new advantages not found in currently available wrist rests and overcomes many disadvantages of such currently wrist rests.

An adjustable wrist rest assembly preferably includes a base housing and a pump assembly residing in the housing. A bladder is provided in fluid communication with the pump where the bladder is configured and arranged to receive a user's wrist region thereon. As stated below, the entire wrist rest assembly may be composed of a bladder alone without a housing. An optional pump button may be connected to the pump assembly with an optional release button connected to the pump assembly. The configuration of the bladder custom adjusts the receipt of the user's wrist region thereon and the comfort associated therewith.

It is an object of the present invention to provide a wrist rest assembly that is height adjustable.

It is a further object of the present invention to provide a wrist rest assembly that has a firmness that is adjustable.

Another object of the present invention is to provide a wrist rest assembly that can be varied manually or automatically.

Yet another object of the present invention is to provide a wrist rest assembly that is interactively adjustable.

A further object of the present invention is to provide a wrist rest assembly that includes heating, cooling and/or massage capability.

Another object of the present invention is to provide a wrist rest assembly that is lightweight and easily transportable.

### BRIEF DESCRIPTION OF THE DRAWINGS

The novel features which are characteristic of the present invention are set forth in the appended claims. However, the invention's preferred embodiments, together with further objects and attendant advantages, will be best understood by reference to the following detailed description taken in connection with the accompanying drawings in which:

FIG. 1 is a perspective view of the wrist rest in accordance with the present invention; and

FIG. 2 is a cross-sectional view through the line 2-2 of FIG. 1;

FIG. 3 is a cross-sectional view of an alternative embodiment of the present invention;

FIG. 4 is a cross-sectional view of another alternative embodiment of the present invention;

FIG. 5 is a cross-sectional view of an alternative embodiment with multiple chambers; and

FIG. 6 is a cross-sectional view of another alternative embodiment with multiple chambers.

### DETAILED DESCRIPTION OF THE PREFERRED EMBODIMENT

The present invention provides for a new and unique enhanced comfort wrist rest assembly 10 that has particular use when used in conjunction with a computer keyboard (not shown). It should be understood that this is merely one use and the present invention can be used for other purposes and in other environments.

The wrist rest assembly 10 of the present invention can utilize many of the cushioning materials, construction methods and other materials found in the prior art wrist rest construction. These materials would include many different types of foamed plastics (such as polyurethane foams etc), gels, resilient nonwoven materials, oil filled layers, visco-elastic foams, TPE'S, silicones, or many other cushioning materials described in the prior art. These materials could be used independently or in various layers and combinations. The prior art also describes methods wherein these cushioning materials in wrist rests are frequently covered with a fabric layer or nonwoven as a top surface to provide for aesthetics and durability. The present invention can also use any of these types of top cover materials.

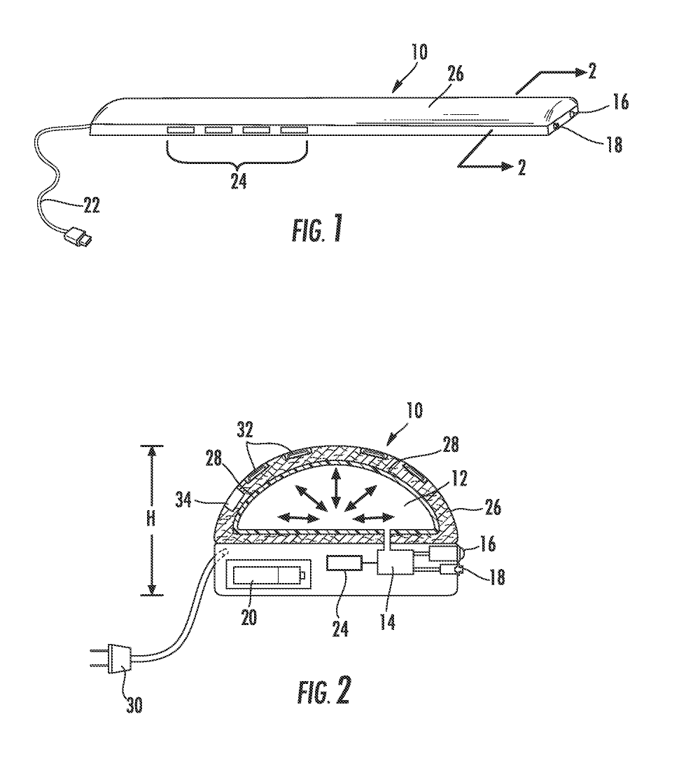

In contrast to known wrist rest assemblies discussed above, the present invention, referring to FIGS. 1 and 2, is novel and unique in that it uses one or more inflatable chambers 12 that can be inflated or deflated to provide for an adjustment in height H and firmness. This chamber (or chambers) 12 can be inflated through an integrated hand activated pump 14 and pump button 16 to inflate the chamber 12 with release valve 18. Alternatively, the pump 14, pump button 16 and release valve 18 may be electronically controlled. If the pump 14 is electronically controlled, it may be powered by any electrical source, such as a battery power supply 20 or by current supplied through the USB cable 22 to a USB port of the computer (not shown). Other protocols, such as IEEE-1394 (Firewire), can be used as well. Via this computer connection, the wrist rest assembly 10 can, if desired, be controlled through commands provided through the USB port using software on the computer that communicates with a computer controller 24 in the wrist rest assembly 10. These commands can be either user-driven commands (such as depressing function keys on a Keyboard) or automatic (or semi-automatic) adjustments controlled by the computer on an intermittent or continuous basis.

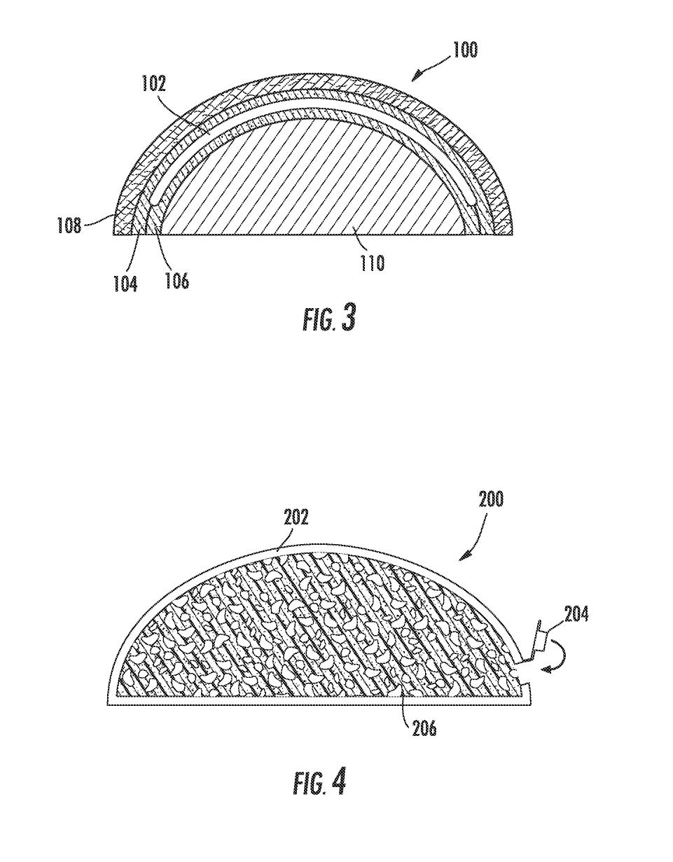

In another embodiment 100 of the invention, as shown in FIG. 3, a structure can be provided where an inflatable chamber 102 is positioned inside of two, preferably molded, layers 104, 106 of polyurethane gel material. The top layer of the polyurethane gel 104 is covered on its upper surface with an aesthetic fabric or nonwoven material 108 to provide for a durable and smooth surface against the user's wrist. Beneath the lower layer of polyurethane gel 104, 106 is a semi rigid base layer 110 to keep the wrist rest stable on the desktop. The base layer 110 is somewhat non-slip to keep the wrist rest in place on a desk top. The positioning of the air chamber 102 within the layers 104, 106 of gel has been found to be beneficial, as the user feels the support of the air, but the cushioning of the gel 104, 106 to absorb movement and vibration.

Referring back to FIGS. 1 and 2, the wrist rest assembly 10 includes a small electronic pump and the control circuitry 24 that can be connected to the USB port of a computer or laptop. The USB port connection can provide both the power for the operation for the pump 14 and also serial communication with the computer device for inflation and deflation commands. The USB port can generally deliver approximately 200 ma or more of power from the computer, which is enough to power a small pump. An electronically controlled release-valve system 18 allows air to flow out of the chamber 12 when desired for deflation. A device driver for the computer will allow for the inflation and deflation of the wrist rest 10 by depressing select keys on the keyboard (i.e. Perhaps F1 inflates, F2 deflates). In addition, the user can select an automatic inflation/deflation cycling mode which will continually or intermittently adjust the height and/or firmness of the inflated internal bladder 12 throughout the day. It is envisioned that the user will be able to select from several automatic profiles which control the level of inflation and the frequency of variability. By having the wrist rest 10 continually or intermittently vary its height, the user may maintain comfort throughout a long period of data entry, and may also avoid repetitive stress injuries to the hand and wrist and fingers.

Since the wrist rest may occupy one USB connection to the computer, it is also envisioned as part of this invention, that the wrist rest might incorporate a USB hub 24 connection that would allow the user to conveniently plug in a mouse or other devices to a USB connection. This feature may likely be more important on a laptop computer where existing USB connections are limited. The incorporation of a USB hub 24 into a wrist rest assembly 10 of the present invention will save the need to utilize a separate hub device, and create additional USB connection points for the user.

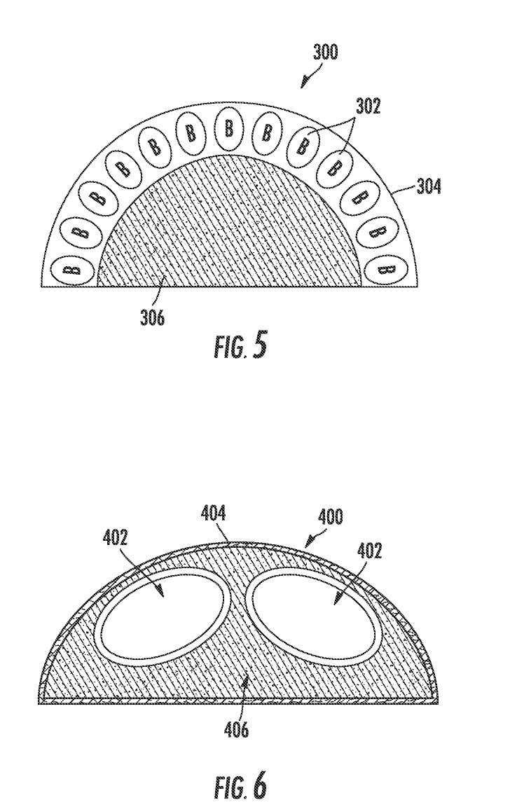

In a further variation of the above embodiment, further embodiments 300 and 400, as seen in FIGS. 5 and 6, are is envisioned that the wrist rest 10 may have more than one air chamber 302 which can be inflated or deflated separately. In these multi-chamber embodiment 300 and 400, the shape of the wrist rest 10 from front-to-back or side-to-side can also be varied automatically. Multiple chambers 302, 402 can be designed to customize the comfort, change the angle of the wrist from front to back and side to side, but also can be used to alleviate pressure on the wrist by alternating pressure between the chambers 302. Fabric 304, 404 can also be used to cover and contain the multiple chambers 302, 404 with a foal or gel cushion 306, 406 therein in similar fashion to that described above. The use of a series of small chambers 302 where the cells alternately shift from low to high pressure can create a wrist rest 300, 400 that has a relatively stable shape but where the pressure is not static on the wrist. This is similar to the pressure relieving technology in some air inflated hospital mattresses. FIGS. 5 and 6 illustrate the wide use and application of the present invention employing inflatable bladder technology in various configurations.

This invention is intended to cover all possible configurations of the wrist rest 10. The inflatable chamber design can be of many different shapes and can also be made up of any number of different separately controllable shaped chambers. While it would appear most desirable to inflate the chamber 12 utilizing air, it is also conceivable that a fluid system could be used. In a fluid system, the fluid would be pumped from one reservoir area to another to make adjustments. The inflatable chamber 12 could be integrated into the wrist rest 10 in a variety of ways. While it may be desirable for the inflatable chamber 12 to be beneath a top layer of foam or gel cushioning material 26, it is also conceivable that the inflatable chamber 12 could be the top surface of the wrist rest 12, or just beneath an aesthetic fabric layer, such as the layer 108 in FIG. 3. In addition, in other versions of the product, the inflatable chamber 12 could be used without additional cushioning layers as the main body of the wrist rest, to provide a lighter weight or less expensive version. It is also possible to use the air chamber within a minimal strategically formed outer gel or foam structure to provide for a light weight yet highly supportive wrist rest that would be excellent for portability such for use with laptop computers. In a deflated state, such a version of the wrist rest could fit in a small area for transport, and might even be able to fold into a small compartment. In an inflated state, this wrist rest would provide the needed support.

The inflatable chamber or bladder 12 could be constructed from a number of different materials, such as films commonly used for this purpose. It has been found that polyurethane films in a thickness range of 1 mil to 10 mils work well for this purpose and are preferred. These films 28 provide both flexibility and softness. Other films that can hold air or liquid can also be used such as a variety of polyolefin films or also PVC films. Fabrics coated with or laminated to any of these materials can also be used.

Another embodiment of the invention would be to incorporate the above described adjustable wrist rest assembly 10 within a keyboard assembly itself, so that the adjustable wrist rest was built into the front of the keyboard. In such a configuration, the wrist rest 10 might exist in multiple separate areas on the keyboard or as one continuous rest. In a configuration where the wrist rest was a built-in part of the keyboard, the USB port connection for the keyboard could of course be utilized to power the inflation pump. In addition, this USB connection would allow for computer control or manual control of the inflation of the wrist rest without a separate connection. As with any of the above described embodiments, this “built-in” wrist rest could also be manually adjusted through an integrated manual pump.

In still another embodiment of the invention, the inflatable chamber 10 could be powered by an internal battery supply 20 or an external power adapter 30, and either directly controlled with an inflation/deflation switch affixed to the wrist rest assembly 10, or controlled through a “Bluetooth” or other wireless connection to the computer. As previously described, the inflation could be specifically set by the user, or could be varied per an automatic profile.

While it is likely to be viewed as desirable to have an electrically operated inflation/deflation mechanism, both for user convenience and to allow the ability for automated inflation/deflation cycling, it is also envisioned that an embodiment of the invention may not involve any electric pump mechanism. A non-electric embodiment of the invention would involve a similar construction method to that described above, but instead of an electric actuated pumping mechanism to inflate and deflate the air chamber, an integrated manual pumping mechanism 16 could be used. This manual pump mechanism 16 could be an integrated dome pump with check valves such as is manufactured by Dielectrics, Inc. in Chicopee, Mass. and found in such products as the Reebok pump athletic shoe. Alternatively, almost any other manual pump inflation mechanism 16 could be used including an attached “pouch” pump or ball pump assembly. The deflation mechanism 18 in this case could be a manually actuated release valve or button to bleed off air. It could also be a regulated bleed-off valve that can be set to a prescribed pressure.

Referring to FIG. 2, the present invention also contemplates the integration of heat, cooling and/or massage features into a wrist rest assembly 10 to further improve comfort or alleviate repetitive stress for the user. These features can be integrated with the height adjustable bladder embodiments described above, or can be integrated separately or in any combinations thereof.

In one embodiment of the invention, one or more small resistive heating element 32 are integrated beneath the top surface of the wrist rest 10. This resistive heating element 32 can be directly below the fabric 26, or beneath one or more of the cushioning layers. In general, the heating element should be relatively close to the user to avoid too much insulation from the cushioning material. This heating element can be powered by the USB cable 22 to a USB port and also controlled by this port as described in other embodiments. The heating element 32 can alternatively be powered by battery current source 20 or external power adapter 30, and controlled through either an integrated thermostat or switch or by the computer through the USB, Bluetooth, or any other communications protocol or method. It may be desirable in some cases to use battery or external power if more heat is desired than can be generated through the USB connection 22. The USB port of a computer can provide 200 ma or more of power as noted above.

In another embodiment of the invention, a Peltier Junction thermo-electric heat pump is used to provide either heating or cooling for the user on the surface of the wrist rest. The Peltier Junction device would be mounted near the surface of the wrist rest. It would be advantageous for heat or cooling transfer to mount the Peltier Junction as close to the surface as possible, but for comfort it may be desirable to have a thin layer of gel or other cushioning above the Junction. Ideally, the cushioning material should be as conductive to heat or cooling as possible or be thin enough so as not to impair the heat or cooling transfer. The Peltier Junction can be controlled so that the top surface becomes either heated or cooled. When the top surface of the Peltier Junction is cooled, the bottom becomes heated and vice versa. By mounting the Peltier Junction device just above the inflatable air chamber, the unwanted heat energy or cooling can be draw away from the device by a small constant flow of air through the chamber. If we want to provide a cool surface on the wrist rest for the user, the top surface of the Peltier Junction can be set to cool, while the bottom surface becomes warm. Because the Junction sits on top of the air chamber, the unwanted heat on the bottom surface of the Junction can be drawn away. In order to accomplish this, we run the small pump to the inflatable chamber to create a constant flow of air through the system. The release valve is also controlled to allow an appropriate amount of air to flow out to maintain the correct inflation pressure.

Again, as is described in other embodiments, it may be desirable in some cases to use battery 20 or external power 30 for more powerful heating or cooling features. Also, while the use of the air chamber 12 is a convenient method to bleed off unwanted heat or cooling from the above described Peltier junction, it is envisioned that other methods could be used to bleed away unwanted heat or cold, including the use of integrated air pathways to provide for the controlled transfer of energy. Also, a small fan or other method could be used to accomplish this purpose as well. Other methods of heating and/or cooling can also be used and would still be within the scope of the current invention.

In another embodiment of the invention, the wrist rest incorporates one or several small massage “motors” 34 or other vibration generating devices. One or more of these devices 34 can be integrated somewhere beneath the surface, providing the user with a massage on command or automatically. Once again, this massage feature can be powered through the USB connection 22 to a USB port on a computer and controlled thereby as well. It can also be powered separately through the battery pack 20 or an external power adapter 30. In such cases it can be controlled by a simple on-board switch, or through the computer USB, Bluetooth, or any other connectivity protocol or method.

In yet another embodiment 200 of the wrist rest assembly of the present invention, as seen in the cross-sectional view of FIG. 4, it is also possible that that the bladder 202 can automatically inflate in a similar fashion to a self-inflating camping mattress. In this embodiment, it is envisioned that the bladder 202 includes a valve 204 that is opened to allow air to rush in and then tightened by the user when the inflation level is achieved. Open celled foam 206 is preferably used internally in the bladder 202 to create an outward spring-biasing force to urge the bladder 202 to a substantially inflated state. Thus, the foam 206 provides a self-inflate feature. The user then releases the valve 204 and compresses the wrist rest 200 manually to deflate, and retightens the valve 204 in the semi-inflated or un-inflated state.

This embodiment provides an alternative mechanism and method for inflation of the wrist rest assembly of the present invention. The use of the aforementioned bladder 200 and open cell foam 206 therein may be more well suited for certain applications and environments than the above methods that employ a manual pump or the electric pump, but could achieve the same or similar goals. In some cases, the automatic inflation and adjustment of the embodiment shown in FIG. 4 might be easier for the user than a manual pump. For custom adjustment, the user can release the valve 204, and then apply pressure to the wrist rest 200 so it molds to the wrists. The user can then tighten the valve 204 to hold the air content exactly at that point. This embodiment of FIG. 4 may be configured with or without an outer housing depending on the application and environment at hand.

Any of the features described above can be combined in various combinations either together or each separately, and it would be appreciated by those skilled in the art that various changes and modifications can be made to the above embodiments and described features without departing from the spirit of the present invention. It is also contemplated as part of this invention, that any of the embodiments or individual features described as applied to a separate wrist rest assembly can also be integrated directly into a keyboard construction or to a laptop computer itself. All such modifications and changes are intended to be within the scope of the present invention.

What is claimed is:

1. An adjustable wrist rest assembly, comprising:
a pump assembly residing in the housing;
a bladder in fluid communication with the pump; the bladder being configured and arranged to receive a user's wrist region thereon; and
whereby configuration of the bladder custom adjusts the receipt of the user's wrist region thereon and the comfort associated therewith.

2. The adjustable wrist rest assembly of claim 1, further comprising:
a cover layer residing over the bladder.

3. The adjustable wrist rest assembly of claim 1, wherein the pump is electrically powered.

4. The adjustable wrist rest assembly of claim 3, wherein the pump is electrically powered by a computer's USB port.

5. The adjustable wrist rest assembly of claim 1, further comprising:
a USB hub residing in the base housing.

6. The adjustable wrist rest assembly of claim 1, further comprising:
means for controlling configuration of the bladder from a PC.

7. The adjustable wrist rest assembly of claim 1, further comprising:
a massaging device in communication with the bladder.

8. The adjustable wrist rest assembly of claim 1, further comprising:
a heating device in communication with the bladder.

9. The adjustable wrist rest assembly of claim 1, further comprising:
a cooling device in communication with the bladder.

10. The adjustable wrist rest assembly of claim 1, wherein the pump is manually powered.

11. The adjustable wrist rest assembly of claim 1, further comprising:
cushioning elements in communication with the user's wrist region for added comfort.

12. The adjustable wrist rest assembly of claim 1, further comprising:
a pump button connected to the pump assembly; and
an a release button connected to the pump assembly.

13. The adjustable wrist rest assembly of claim 1, further comprising:
a base housing; the pump and bladder residing in the housing.

14. The adjustable wrist rest assembly of claim 1, further comprising:
means for automatically adjusting an amount of inflation of the bladder.

15. The adjustable wrist rest assembly of claim 1, wherein the bladder includes a plurality of chambers;

16. The adjustable wrist rest assembly of claim 15, wherein the plurality of chambers are individually adjustable.

17. The adjustable wrist rest assembly of claim 16, wherein every other alternate chambers are configured to periodically drop in pressure to relieve stress on a wrist.

18. A wrist rest assembly, comprising;
a electronic massage, heating and/or cooling element powered by a USB connection or internal power supply.

19. A wrist rest assembly, comprising:
a bladder having an aperture; the bladder being configurable between a substantially collapsed state and a substantially fully inflated state;
a valve residing in the aperture; the valve controlling the amount of air entering and leaving the bladder;
a spring-biasing means located in the bladder; the spring biasing means directing the bladder toward the substantially fully inflated state; and
whereby opening the valve permits the bladder to be custom configured between the substantially collapsed state and the substantially fully inflated state and whereby closing the valve causes the bladder to substantially remain it a state between the substantially collapsed state and the substantially fully inflated state.

20. The wrist rest assembly of claim 19, wherein the spring-biasing means is open cell foam.

21. The wrist rest assembly of claim 19, wherein the bladder is manually collapsed with the valve open to move the bladder toward the substantially collapsed state.
